(19) United States
(12) Patent Application Publication
(10) Pub. No.: US 2014/0059118 A1
(43) Pub. Date: Feb. 27, 2014

(54) Method and Devices for Enhanced File Transfer

(71) Applicants: Swapna A. Pidady, Streamwood, IL (US); Ronald W. Cornwall, West Chicago, IL (US)

(72) Inventors: Swapna A. Pidady, Streamwood, IL (US); Ronald W. Cornwall, West Chicago, IL (US)

(73) Assignee: Infinite Convergence Solutions, Inc, Arlington Hts, IL (US)

(21) Appl. No.: 14/011,424

(22) Filed: Aug. 27, 2013

Related U.S. Application Data
(60) Provisional application No. 61/693,650, filed on Aug. 27, 2012.

(51) Int. Cl. H04L 29/08

(52) U.S. Cl. CPC H04L 67/06
USPC 709/203

(57) ABSTRACT

This invention is an enhanced method and devices which result in a more efficient method to transfer files between mobile clients.

### CROSS-REFERENCE TO RELATED APPLICATIONS

This claims priority to U.S. provisional patent application 61/693650 filed on Aug. 27, 2012 by the present inventors.

### FEDERALLY SPONSORED RESEARCH

None.

### SEQUENCE LISTING

None.

### FIELD OF THE INVENTION

This invention is an enhancement to the previously known RCS telecommunications standards related to receiver initiated file transfer.

### BACKGROUND OF THE INVENTION

In RCS (Rich Communication Service) specifications as well as other mobile specifications from OMA and 3GPP, either the sender client or the receiver client can initiate a file transfer. In the current version of RCS, the data session with the sender client is always established first, before the receiver session is established.

Establishment of the file sender session before the requester session is established creates a race condition with the sender possibly sending data before the receive client is ready. There are several poor solutions to this problem. This race condition can possibly be solved by continual sending of the file's first data chunk (without acknowledgement by the receiving client.) This results in needless network traffic overhead. Another solution considered was insertion of an artificial delay on the sender side. This solution is not optimal since wait time has been known to vary by type of client (for example, a prepaid mobile device client will need extra time to establish a session since additional processing and query to a prepaid server is necessary). A single artificial timer would be inappropriate and result in unnecessary delays to a majority of clients. Still another solution considered was to develop a more complicated Application Server which is capable of storing data until the receive client is ready. This store and forward method results in a more complicated and costly Application Server than is necessary resulting in added software expenses as well as requiring adequate storage space on the Application Server in order to buffer the data.

### SUMMARY OF INVENTION

The best solution to the timing problem during file transfer was found to be addition of an added message sequence to the previous published file transfer process whereby the sender client waits for a “Ready to Receive” message prior to beginning the file transfer. With RCS 5, re-use of an empty MSRP SEND command, or use of MSRP SEND with a special “Ready to Receive” flag, is the best known “Ready to Receive” message.

### GLOSSARY

3GPP Third Generation Partnership Project
Application Server An application server provides software applications with services such as security, data services, transaction support, load balancing, and management of large distributed systems.
AS Application Server
IMS IP Multimedia Subsystem
MMS Multi-Media Message
MSRP Message Session Relay Protocol, a protocol for transmitting a series of related instant messages in the context of a session.
OMA Open Mobile Alliance
RCS Rich Communication Suite, RCS is a set of core mobile services described in mobile standards from 3GPP and Open Mobile Alliance (OMA). Services include Voice Call, Presence, Instant Messaging, Video Share, Image share, SMS and MMS.
SIP Session Internet Protocol
SMS Short Message Service

### BRIEF DESCRIPTION OF DRAWINGS

FIG. 1 shows a File Requester client and a File Sender client transferring a file from the sender to the receiver in N chunks via an Application Server. As per industry specifications, the MSRP connection between the Sender client and Application Server is established followed by the establishment of the MSRP connection establishment between the Application Server and the requester client.

FIG. 1 also shows the current innovation of the “Ready to Receive” being sent by the Requester Client to the AS, as well as the “Ready to Receive” from the AS to the Sender Client. In both cases the “Ready to Receive” is confirmed with a 200 OK message consistent with the SIP protocol. FIG. 1 also shows the Sender Client waiting for the “Ready to Receive” signal prior to proceeding with the transfer of the file data.

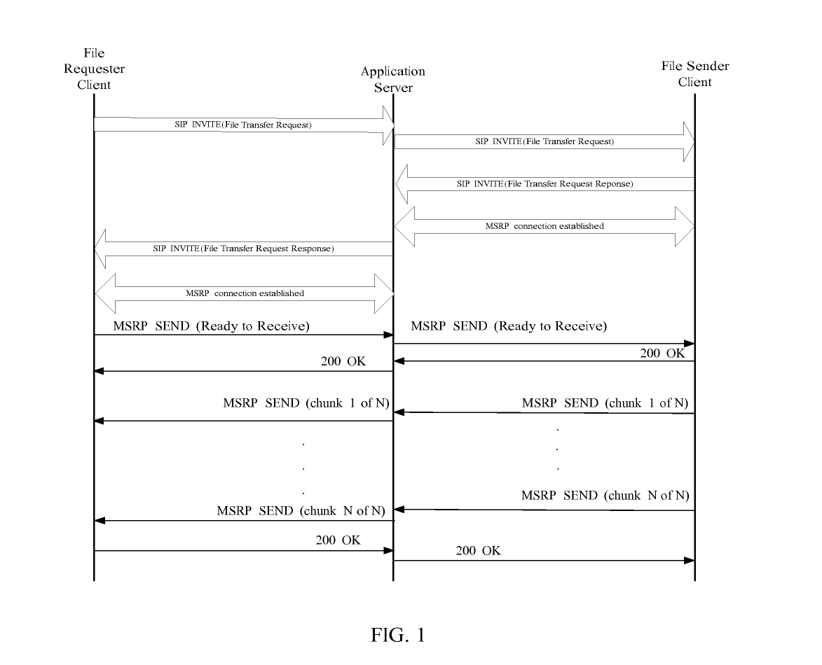

### DETAILED DESCRIPTION

In the best mode of the invention, a SIP message from the File Requester Client to the Application Server (AS) is used to indicate a file transfer request. The file transfer request (a similar message with different header) is then passed on from the AS to the Sender Client. The file sender client issues a response back to the AS which passes on the response to the original file requester. The Sender Client then establishes an MSRP session to the AS. Shortly thereafter a MSRP session is then established between the AS and the requester.

With this innovation, after the MSRP session is established between the AS and the requester client is established, a Ready to Send indicator is sent from the requester client to the AS. The AS then Transmits a similar Ready to Send indicator to the sender client. Only after the Ready to Send indicator is received by the sender client does the file transfer begin at the sender client to the receiver via the AS.

What we claim is:

1) A file transfer method comprising:
a) sending an indicator from the requester client to indicate that the requester client is ready to receive file content;
b) accepting and processing the indicator by the Application Server;
c) Retransmission of the indicator by the Application Server to the sender client;
d) Receiving the indicator by the sender client;
e) Only after receiving the indicator, begin transmitting the file content from the sender client through the application server to the receiver client.

2) The method of claim 1 that uses an MSRP SEND command as the ready to receive indicator.

3) A file transfer client that sends a ready to receive file transfer indicator.

4) The file transfer client of claim 3 that uses an MSRP SEND command as the ready to receive indicator.

5) A file transfer client that receives a ready to receive file transfer indicator.

6) The file transfer client of claim 5 that receives a MSRP SEND ready to receive indicator.

7) The file transfer client of claim 6 that begins the file transfer when the ready to receive indicator is received.

8) An Application Server that receives a ready to receive file transfer indicator.

9) An Application Server that sends a ready to receive file transfer indicator.
